(19) United States
(12) Patent Application Publication
(10) Pub. No.: US 2003/0115365 A1
(43) Pub. Date: Jun. 19, 2003

(54) Transcoding information in a first markup language into a second markup language

(76) Inventor: Teddy Lindsey, San Diego, CA (US)

Correspondence Address: BROBECK, PHLEGER & HARRISON LLP, 12390 EL CAMINO REAL, SAN DIEGO, CA, 92130, US

(21) Appl. No.: 10/029,700

(22) Filed: Dec. 19, 2001

(51) Int. Cl. G06F 15/16

(52) U.S. Cl. 709/246; 709/230

(57) ABSTRACT

A system for transcoding information in a first markup language into a second markup language is provided. A request to view a Web page is made. Information from the Web page in a first markup language is automatically retrieved. The information is then normalized. A browser that is being used by the computer that requested to view the Web page is detected and a second markup language is determined, where the browser of the computer can use the second markup language. A renderer then transcodes the information into the second markup language.

### FIELD OF THE INVENTION

This invention generally relates to the field of computer software and Internet applications. More particularly, the present invention relates to a system for transcoding a Web page from a first markup language into a second markup language.

### BACKGROUND

The remarkable growth of the Internet, and in particular the World Wide Web (“WWW” or “Web”), was aided greatly by the global adoption of key technical standards. For example, the worldwide acceptance of HyperText Markup Language (“HTML”) as the markup lingua franca of the Web prevented internecine warfare over this indispensable element of the WWW protocol.

The relatively recent advent of wireless data services and mobile devices able to transmit and receive digital data wirelessly has led to a second stage of Internet evolution, the wireless Internet. Many of the mobile devices that utilize the Internet include a data browser, sometimes known as a microbrowser, which works in a fashion similar to a desktop computer-based Web browser. Unlike desktop computer Web browsers, however, browsers used by a mobile devices typically do not support HTML natively, and instead utilize a variety of markup languages, including but not limited to the Handheld Device Markup Language (“HDML”), the Wireless Markup Language (“WML”), the Compact HTML (“cHTML”) and variants of HTML which partially support the HTML lexical elements and syntax. This proliferation of markup languages has directly resulted in daunting challenges for developers wishing to create applications accessible by these mobile devices. For example, the lack of a single markup language common to all mobile devices forces developers to learn and stay abreast of changes in all the markup languages supported in their applications, resulting in a considerable burden. Moreover, the great variety of mobile devices and their associated form factors, display sizes and capabilities has made creating applications that can accommodate mobile devices with widely differing attributes and markup languages expensive and onerous. In addition, the rapid growth of technology embodied within the mobile devices, their supporting wireless communication systems, and the mobile application standards themselves mandates that mobile application developers create applications that can rapidly incorporate these changes.

Developers have adopted a number of approaches to address the challenges of creating Web applications that can be accessed by mobile devices. One approach is to implement individual applications for each combination of class of mobile device and markup language. For example, an application designed to support wireless phone-class devices and three markup languages would require the development of three separate applications. If it were later necessary to support additional devices, such as PDAs, or new markup languages, additional applications would have to be developed and tested. There are several disadvantages to this method. First, it is not scalable in terms of the resources and development time required to implement. Any changes made to the underlying application or site have to be made in all the markup languages. Maintenance of such mobile applications is therefore expensive and time consuming. Second, such applications do not lend themselves well to optimization for performance and scalability, especially since so much time is devoted to making the applications work at all, let alone efficiently. Lastly, creating mobile applications in this fashion requires specialized knowledge of mobile devices and their markup languages, knowledge that might take months to acquire, and at great cost.

Another approach to dealing with the variety of markup languages is template-driven markup language generation. An example is the use of Extensible Stylesheet Language (“XSL”) templates to render content in Extended Markup Language (“XML”) format into other markup languages in a process described in the Extensible Stylesheet Language Transformations (“XSLT”) standard. Typically the application designer creates the underlying application to generate XML-based content, and then develops XSL templates for each markup language and class of mobile device, that describe how the XML should be appropriately transcoded. With this approach, the core application is created only once, instead of being duplicated. This approach, however, also has disadvantages. First, specialized knowledge of mobile devices and their associated markup languages is required. Second, yet another set of relatively new languages, namely XML, XSL, and XSLT, are utilized, with the resulting learning curve for developers. Lastly, this approach is maintenance intensive if the underlying application changes frequently, as the XSL templates have to be modified accordingly.

Another example of dealing with multiple markup languages is through the use of a Web scraping server or proprietary proxy server. In this approach, a specialized server parses HTML content, searches for programmed patterns or specified tags, extracts the desired content and formats the extracted information into another markup language appropriate for the mobile device requesting the information. However, this approach results in a fragile, expensive, and maintenance intensive solution. Also, because the scraping or proxy server processes all mobile device requests, additional network latency or delay is introduced, negatively impacting performance. Moreover, a performance bottleneck in the scraping or proxy server will effectively limit maximum data throughput. Additional, this type of transformation is commonly implemented by an external entity, and access is thus afforded to potentially sensitive data, over which the enterprise has little or no control.

Accordingly, there is a long felt need to provide a system and method for transcoding information in a first markup language into information in a second markup language, for example to allow various users of mobile devices that utilize various markup languages to access information on the Web.

### SUMMARY OF THE INVENTION

One embodiment of the present invention comprises a method of transcoding information in a first markup language into a second markup language, the method comprising the steps of: responding to a request to view a Web page by retrieving information from the Web page, wherein the information is in a first markup language; normalizing the information; determining a second markup language that can be used by a browser using device detection, wherein the browser is used by a computer that is to view the information; and transcoding the information into the second markup language.

Another embodiment of the present invention comprises a method of transcoding information in a first markup language into a second markup language, the method comprising the steps of: responding to a request to view a Web page via a computer; retrieving information from the Web page, wherein the information is in a first markup language; normalizing the information; and transcoding the information into a second markup language, wherein the computer is adapted for utilizing the second markup language.

Another embodiment of the present invention comprises a method of transcoding information in a first markup language into a second markup language, the method comprising the steps of: responding to a request to view a Web page; retrieving information from the Web page, wherein the information is in a first markup language; device detection to determine the second markup language that is used by the browser; and transcoding the information into a second markup language, wherein the computer is adapted for utilizing the second markup language.

Another embodiment of the present invention comprises a system for viewing a Web page by a computer that utilizes a markup language, the system comprising: a computer, wherein the computer requests to view a Web page; information from the Web page, wherein the information is in a first markup language; a device detector, wherein the device detector determines a second markup language that the computer utilizes; and a renderer, wherein the renderer transcodes the information into the second markup language, wherein the information is sent to the computer.

Another embodiment of the present invention comprises a system for viewing a Web page by a computer that utilizes a markup language other than the HyperText Markup Language (HTML), the system comprising: a computer, wherein the computer requests to view a Web page; information from the Web page, wherein the information is in a first markup language; a normalizer, wherein the normalizer normalizes the information in the first markup language into an intermediate markup language; and a renderer, wherein the renderer transcodes the information in the intermediate markup language into a second markup language, wherein the second markup language is a markup language that the computer utilizes and the second markup language is a markup language other than HTML.

Another embodiment of the present invention comprises computer executable process steps operative to control a computer, stored on a computer readable medium, comprising: a plurality of steps to receive data required for subsequent calculations; and a plurality of steps to automatically transcode information in a first markup language into a second markup language, wherein the second markup language is automatically determined.

Another embodiment of the present invention comprises a method of transcoding information in a first markup language into a second markup language, the method comprising the steps of: responding to a request to view a Web page; automatically retrieving information from the Web page, wherein the information is in a first markup language; automatically transcoding the information in the first markup language into an intermediate markup language; automatically detecting a browser used by a wireless mobile device that is to view the information; automatically determining a second markup language, wherein the second markup language is a markup language different from the first markup language and wherein the browser of the wireless mobile device is adapted for utilizing the second markup language; automatically selecting a renderer that is associated with the second markup language from a plurality of renderers; automatically sending the information in the intermediate language through the renderer, wherein the renderer coverts the information into the second markup language using smart automatic object conversion; and automatically streaming the information in the second markup language to the wireless mobile device in real-time over a system of networked computers.

A technical advantage of an embodiment of the present invention is that it allows a mobile device that can only read information in a certain markup language to read information on the Web regardless of the markup language that is used for the content on the Web. Additionally, information on a Web page can be viewed by various computers, regardless if the computer can read information in the markup language stored on the Web page. Further, creators of Web pages do not have to be concerned with the ability of mobile devices that do not understand one markup language, such as HTML, to view these Web pages.

A further technical advantage of an embodiment of the present invention is that it provides a system for enabling the rapid creation of mobile applications.

A technical advantage of another embodiment of the present invention is that a system for the creation of mobile applications in a standards-based, non-proprietary, scalable, extensible, and efficient manner is provided.

Other objects, features, and technical advantages of the present invention will become more apparent from a consideration of the detailed description herein and from the accompanying drawings.

### BRIEF DESCRIPTION OF THE DRAWINGS

Reference is now made to the following description and the accompanying drawings, in which:

FIG. 1 is a schematic system diagram illustrating a portion of a computer, including a CPU, conventional memory, and communications hardware;

FIG. 2 is a flow chart of an embodiment of the present invention;

FIG. 3 is a flow chart of an embodiment of the present invention; and

FIG. 4 is a schematic system diagram illustrating an embodiment of the present invention.

### DETAILED DESCRIPTION OF AN ILLUSTRATIVE EMBODIMENT

The following detailed description refers to the accompanying drawings. Other embodiments of the present invention are possible and modifications may be made to the embodiments without departing from the spirit and scope of the invention. Therefore, the following detailed description is not meant to limit the invention. Rather the scope of the invention is defined by the appended claims.

Moreover, for convenience in the ensuing description, the following explanations of terms are adopted. However, these explanations are intended to be exemplary only. They are not intended to limit the terms as they are described or referred to throughout the specification. Rather these explanations are meant to include any additional aspects and/or examples of the terms as described and claimed herein.

A “computer,” as used herein, includes any general-purpose machine that processes data according to a set of instructions that is stored internally either temporarily or permanently, including, but not limited to, a general-purpose computer, workstation, laptop computer, personal computer, set top box, Web access device (such as WEB TV™ (Microsoft Corporation)), Internet-ready mobile phones, wired or wireless laptop computers, smart client devices (that actively fetch data and store it locally), television interfaces, kiosks, cable television, satellite television, broadband networks, electronic viewing or listening devices, wireless devices (such as a personal digital assistant (“PDA”), a cellular or mobile telephone, a mobile WWW enabled phone, a mobile data phone, an electronic handheld unit for the wireless receipt and/or transmission of data, such as a browser-equipped device utilizing WORKSTYLE™ (Wireless Knowledge, Inc.)), or the like.

“Electronic connection,” as used herein, is any connection between electronic devices, including connections via hardwire, Ethernet, token ring, network interface, modem, digital subscriber line, cable modem, wireless, radio, satellite, and combinations thereof. Such connections may be implemented using copper wire, fiber optics, radio waves, coherent light, or other media.

The “system of networked computers,” as used herein, means any system of interconnected computers such as the Internet, an intranet, a virtual private network (“VPN”), a local area network (“LAN”), a wide area network (“WAN”), and the like. The system of networked computers may be any system of multiple computers that are directly or indirectly interconnected by any type of electronic connection. Further, as used herein, the term “network” refers to any such system of networked computers.

A “mobile device” or a “wireless mobile device,” as used herein, is a computer connected wirelessly to a system of networked computers, such as telephones, pagers, PDAs, palmtop computers, laptop computers, Microsoft Windows CE and Pocket PC devices, and all similar devices currently existing or that may be created in the future.

A “mobile application,” as used herein, is a software program that receives requests from mobile devices and creates a response formatted in the appropriate markup language (as indicated by the mobile device), and with respect to the class of the requesting mobile device.

A “markup language,” as used herein, is a computer language used to program a Web page, such that a browser can display the Web page. Markup languages include, but are not limited to HTML, XML, HDML, WML, cHTML, the EXtensible HTML (“XHTML”), the Standard Generalized Markup Language (“SGML”), other known or unknown variants of HTML, and the like. The Voice Markup Language (“VoxML”) is another markup language, which is used for voice-to-computer applications.

A “browser” is a computer program that lets a user look through a set of information, such as information in a markup language. For example, a browser can be a Web browser, microbrowser, data browser or the like.

A “Web application” or “Web site,” as used herein, describes a software system that receives requests from a computer connected to a system of networked computers and responds with markup language formatted content. The content can be static, in which case the content does not vary from user to user and does not involve input from a user, or dynamic, which allows the user to interact with the Web site and, for example, allows the user to request specific information relevant to the user.

A “user” is the entity that desires information to be viewed in a human readable format on a computer. The user can be a person or a computer. “Automatic,” “automatically,” “automated,” or the like, as used herein, means to occur without human interaction. For example, this may mean that the event has occurred using a computer that is programmed to perform the event using information that the computer has received, obtained and/or gathered. Operation of some embodiments of the present invention allow for the elimination of substantial human effort at various phases, such phases are described herein as being “automatic,” “automated,” occurring “automatically,” or the like. However, human intervention may occur such that such phases may be completed manually.

It will be apparent to one of ordinary skill in the art that an embodiment of the present invention, as described below, may be realized in a variety of implementations, including the software, firmware, and hardware of the entities illustrated in the figures. The actual software code or control hardware used to implement the present invention is not limiting of the present invention. Thus, the operation and behavior of the present invention will be described without specific reference to the actual software code or hardware components. Such non-specific references are acceptable because it is understood that a person of ordinary skill in the art would be able to design software and control hardware to implement the present invention based on the description herein.

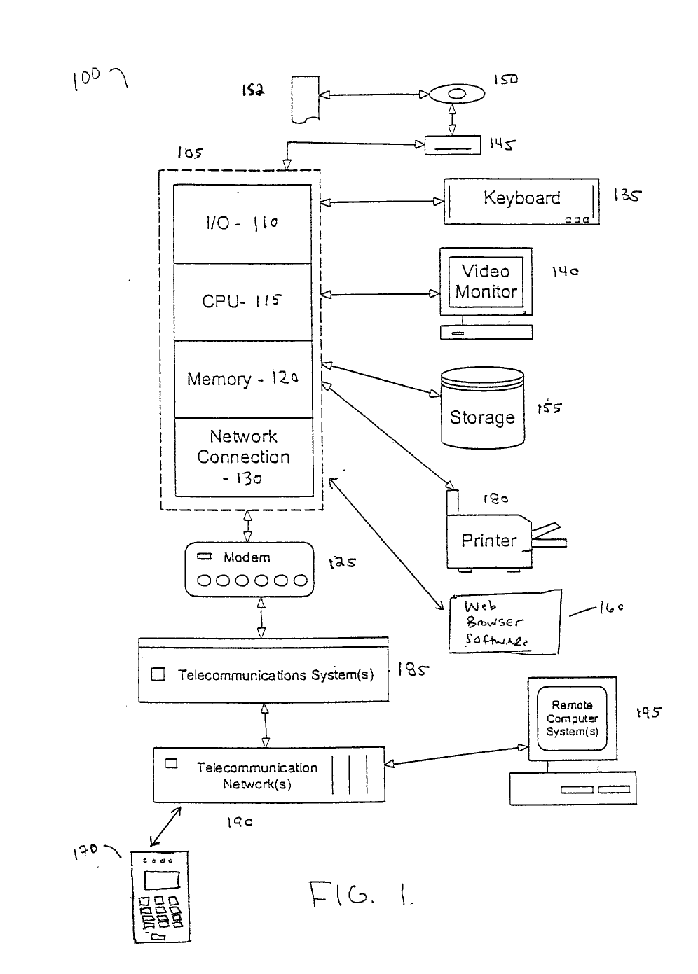

FIG. 1 is a schematic system diagram illustrating a portion of a computer system 100, including a CPU, conventional memory, and communications hardware, used in accordance with an embodiment of the present invention. A user logs onto a system of networked computers, such as by using computer system 100. Computer system 100 uses a browser 160. Computer system 100 is linked to a system of networked computers, such as the Internet. Computer software and hardware may be used to connect the server to the Internet. Browser 160 used by computer system 100, for example, can be any available browser software, such as NETSCAPE NAVIGATOR® (Netscape Communications Corporation) or MICROSOFT INTERNET EXPLORER™ (Microsoft Corporation). Browser 160 provides a remote user access to the URL or IP address of various Web sites and the electronic information stored therein.

Computer system 100 comprises a processor 105 having an input/output (“I/O”) section 110, a CPU 115, a memory section 120, and a network connection 130. Processor 105 is connected to a communications network interface 125, a keyboard 135, a display unit 140, a storage disk 155 (such as a computer hard drive, disk, database or the like) and a CD-ROM or similar unit 145. The CD-ROM unit 145 reads a CD-ROM or similar medium 150, which typically contains programs and data 152. A printer 180 connects to processor 105. A telecommunications system 185 is connected to the system via a network interface 125 (such as a modem) or some other communications device. The telecommunications system 185 allows the system to connect to a telecommunication network 190, such that a user's computer system 100 connects to a remote computer system 195. Alternatively, the system can interact with a mobile device 170. According to an embodiment, the present invention works on a single or plurality of computers and/or is locally or remotely operated.

One environment in which embodiments of the present invention operate is a system of networked computers, wherein general-purpose computers, workstations, or personal computers, such as computer system 100, are interconnected to remote computer system(s) 195 and mobile devices 170 via communication links of various types, such as via telecommunication network(s) 190. Thus, a user's computer system 100 is connected to other computers 195 and 170 over a network interface, modem, Ethernet connection, or other communications link. Electronic information transmitted from the user or other entities is sent from one such computer system 100 to other similar computer systems 195 and 170.

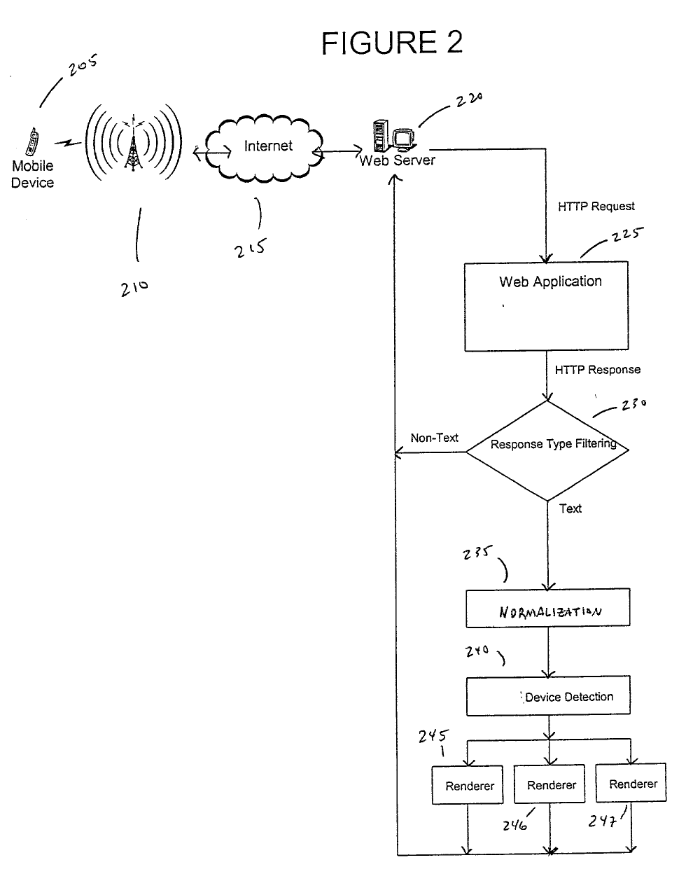

FIG. 2 is a flow chart of an embodiment of the present invention. A user uses a computer 205 to access a system of networked computers, such as the Internet 215. The computer 205 can be any computer, but according to one embodiment, computer 205 is a wireless mobile device. The computer 205 connects to the Internet via a wireless network 210.

Once connected to the Internet, the user requests to view various Web sites and Web pages. When the user requests to view a Web page, the Web server 220 for that Web page receives the request.

The request to view the Web page can be in the form of hypertext encapsulated within a transfer method known as “HTTP” (“Hypertext Transfer Protocol”). HTTP is designed to run primarily over the Transmission Control Protocol/Internet Protocol suite (“TCP/IP”) and conforms to the standard client/server paradigm, in which a client requests data from a server, the server furnishes the requested data to the client, the client further processes the requested data and displays the data to the user. TCP/IP is the set of communications protocols used to connect hosts on the Internet. TCP/IP uses several protocols, the two main ones being TCP and IP. TCP/IP is built into most operating systems and is the primary suite of network protocols employed on the Internet, making it the de facto standard for transmitting data over networks.

If the Web site has any Web applications that are to provide interaction with the user, such applications are run at 225. These Web applications could have been programmed using Active Server Pages (“ASP”) (Microsoft Corporation), the Practical Extraction Report Language (“PERL”), JAVA™ (Sun Microsystems, Inc.), JSP™ (“JavaServer Page”) (Sun Microsystems, Inc.), JAVA™ Servlet, Cold Fusion™ (Allaire Corporation), WEBSPHERE™ (International Business Machines Corporation), and the like. The HTTP response from the Web application is then processed at 230.

Alternatively, if the Web page is a static Web page, e.g., is not generated by Web applications, then the information from the Web page (usually in HTML) is processed at 230.

Regardless of whether a Web application is used, the response received at 230 includes information that is in a first markup language. This first markup language is usually HTML, as most Web pages are coded in HTML.

At 230, the response from the Web page is filtered; HTML text is further processed while non-textual information (such as sound files, video files, images, and the like) is filtered out, that is, removed. The non-textual information is filtered because most mobile devices cannot display or use non-textual information. Therefore, the non-textual information is removed, as it is not necessary for use on mobile device. One method of determining if information is non-textual is by examining the Content-Type header of the HTTP response.

If a computer that could display or use non-textual information requested the Web page, this filtering step 230 is not necessary. In such an instance, the non-textual information is passed along with the textual information. For example, the HTTP user agent header field (or browser agent) along with other HTTP request headers are used to indicate the computer and/or type of browser the computer is using, which is used to determine whether the computer running this browser can display or use non-textual information.

At 235, the information in the first markup language is normalized. Normalizing information involves cleaning up the information such that it is properly formatted, such that, for example, the information conforms to the XML rules for well-formedness or is syntactically and lexically correct. According to one embodiment, to normalize information, the information is coded into an intermediate markup language. For example, if the first markup language was HTML, the information would be normalized into the intermediate markup language XHTML. XHTML is coded more rigorously than HTML and must conform to the rules of structure more than HTML. Therefore, when information is in XHTML, it is easier to rely on information being in a specific format. By normalizing the code, the system can rely on particular information appearing in a particular format, making transcoding easier.

Normalizing information can be accomplished by running the code through a normalizer. The normalizer recognizes the first markup language and makes sure that each line of the code is properly formatted and/or coded. If the line of code is not properly formatted and/or coded, the information is corrected to be properly formatted and/or coded. This can be done using an intermediate markup language, as described herein, or simply by formatting the code in the first markup language.

An example of normalizing code is as follows: The common image tag can be represented as <img src=”sample.jpg” border=0> and will be accepted by most browsers. However, this tag does not conform to XHTML because the “border” attribute value is not contained within quotes and the tag does not have a matching closing tag. Therefore, the common image tag normalized into XHTML would be: <img src=”sample.jpg” border=”0”> </img>.

In another embodiment, the normalizer reads multiple lines of code at a time. Alternatively still, the normalizer can break down all the code for the information and recode the information in the intermediate markup language. In one embodiment, the normalizer is based on algorithms that are provided in the program HTML Tidy by Dave Raggett (information regarding HTML Tidy can be found at http://tidy.sourceforge.net/, which is incorporated herein by reference in its entirety). According to this embodiment, the normalizier is merely based on these algorithms because, unlike HTML Tidy, normalization occurs in real-time and in the computer's memory, as described herein.

According to another embodiment, normalization occurs by the author of the Web page. The author of the Web page can code the information such that it is already normalized. In such an instance, no further normalization is necessary and when the Web page is requested, its information does not have to be normalized.

At 240, device detection occurs. Device detection involves detecting the computer 205 and/or the browser that the computer is using, such that the second markup language can be determined. Device detection is used to determine the second markup language; the second markup language is a markup language that can be viewed using the browser on the computer. Device detection can be performed using any method of detecting the computer and/or the browser that the computer is using.

In one embodiment, device detection is accomplished by referring to the HTTP user agent header field or the signature of the browser. The HTTP user agent header field is a field in the HTTP request header that contains the name and version of the Web browser. For example, if the user is using an OPENWAVE™ (Openwave Systems Inc) WML browser, an HTTP user agent header field is sent containing “Up.Browser/4.1” whereas Internet Explorer sends a header containing “Mozilla/4.0”. When the system sees a HTTP user agent of “Up.Browser/4.1,” the system knows that the browser is an OPENWAVE WML browser and thus the second markup language is WML.

Additionally, to improve device detection, unique signature detection can be performed. Unique signature detection involves device detection using the HTTP user agent header field and, in addition, viewing other HTTP request headers to more accurately determine what browser and/or computer is being used. These other HTTP headers include, for example, the encoding type, device-specific information such as screen dimensions, the number of softkeys, and the like. This additional information, in combination with information from the HTTP user agent header field, can be considered a unique signature for the device.

When device detection occurs, the device is associated with one of a plurality of device rendering classes. Each device rendering class is associated with a particular markup language. Therefore, when a device is associated with a device rendering class, the system knows that this device can use the markup language associated with the device rendering class.

According to one embodiment, a user can customize the system such that certain devices are associated with certain device rendering classes. For example, the user can modify the rules such that a particular device with a particular unique signature (the HTTP user agent header field along with other information as described above) is associated with a particular device rendering class. Alternatively, such association can only be done by the operator of the system and not the user.

If, for some reason, device detection fails to detect a known computer and/or browser, such that a second markup language cannot be immediately determined, a default markup language is used. This default language can be a language that works with common mobile devices. Alternatively, the operator of the system can choose a default language. Alternatively still, the system can make a best guess determination regarding the identity of the computer and its browser, or a guess as to the type of language the computer uses, based on the information received from the computer.

After the step of device detection is performed, the language in which the information is to be transcoded (the second markup language) is identified. This language is identified based on the language that the browser on the device can use. For example, a mobile telephone made by Nokia Corporation will likely accept WML whereas a Qualcomm Incorporated handset will likely accept HDML.

Upon identifying the second markup language, the information is transcoded, or converted, into this desired language. To transcode the information into the desired language, renderers 245, 246, 247 (or transcoders) are used. A renderer is a language converter that transcodes the information in a first markup language (either as non-normalized, normalized, or normalized into an intermediate markup language) into information in a second markup language, the desired language. Each markup language has its own renderer 245, 246, 247. For example, renderer 245 may be for HDML, renderer 246 may be for cHTML, renderer 247 may be for WML, and so on. Additionally, there may be renderers for XHTML, VoxML, HTML (if HTML was not the first markup language) or any other markup language. If, for example, the VoxML markup language was used, the information on the Web page could be heard.

According to one embodiment, if the transcoder is not certain of a conversion, the transcoder examines the information and makes an educated guess (based on rules such as relative positioning between user interface elements, examination of the content of specific tags and attributes, and the like) as to what was intended to be conveyed by the information. The transcoder than re-express that intent as information in the second markup language.

After the renderer 245, 246, 247 transcodes the information into the desired markup language, the information is sent to the computer 205 in real-time. The information can be streamed to the computer 205 or can be sent as a file to the computer 205. In one embodiment, the transcoded information is stored in memory, and then is sent through Web server 220, through the Internet 215, then through the wireless network 210 to computer 205.

Therefore, a user using a wireless mobile device can receive information from Web pages encoded in HTML, regardless of the markup language the mobile device uses. Moreover, the developers of the Web page do not need to know all of the different markup languages that users of different wireless mobile devices use. Instead, according to an embodiment of the present invention, the developers develop the Web page in one markup language and the information is automatically transcoded into the various markup languages, as needed.

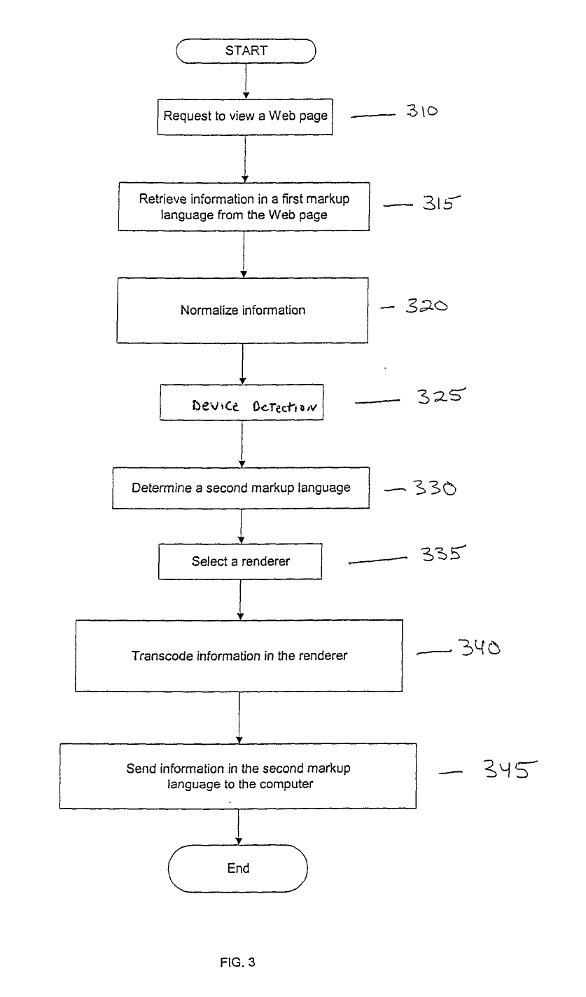

FIG. 3 is a flow chart of an embodiment of the present invention. A user on a computer over a system of networked computers requests to view a Web page at 310.

At 315, information from the Web page is automatically retrieved. The information is in a first markup language, such as HTML.

At 320, the information is automatically normalized, such that the information is in the correct format and style. For example, the information is automatically transcoded from the first markup language into an intermediate markup language, such as XHTML.

At 325, the type of computer, such as a mobile device, that the user is using to view the information and/or the browser the computer is using is automatically detected, such as by using device detection or unique signature detection.

At 330, based on the detection performed in step 325, the second markup language is determined. The second markup language is a markup language that can be used by the browser the computer is using. In one embodiment, the second markup language is different from the first markup language. However, the second markup language could be the same as the first markup language, in which case the information would not have to be transcoded. An example of when a user may want the first and second markup languages to be the same would be if the user merely wanted to normalize the information.

At 335, based on the second markup language, the renderer to be used is automatically selected. The renderer associated with the second markup language is chosen. There is available a renderer for every markup language that the information can be transcoded into.

At 340, the information is automatically sent through the renderer selected in step 335. The renderer transcodes the information into the second markup language, as described herein.

At 345, the information in the second markup language is sent to the computer. This can be done by streaming the information to the computer. Alternatively, the information is saved as a file and is sent to the computer as a file.

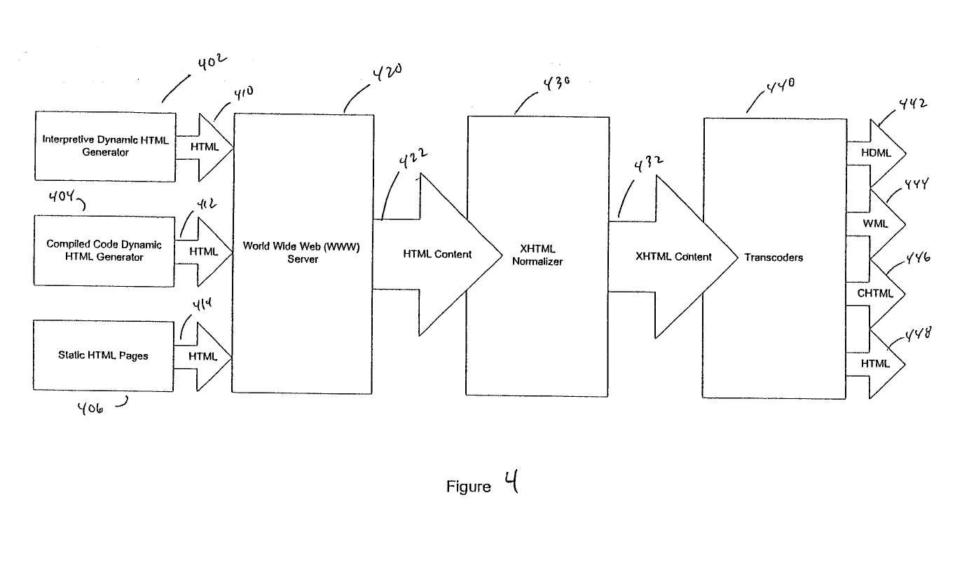

FIG. 4 is a schematic system diagram illustrating an embodiment of the present invention. Information from a Web page is generated, such as static content generator 406 (which generates static code 414 upon request), a compiled content generator 404 (which generates code 412 upon request) and an interpretive dynamic content generator 402 (which generates code 410 upon request). Content generators 402 and 404 can be distinguished by the nature of the computer code being generated. An example of generator 402 is the WORKSTYLE™ product, which has a number of compiled C++ objects that interact to generate dynamic markup code. An example of generator 404 is an Active Server Pages-coded page that generates dynamic content, because an ASP is not compiled but is rather interpreted at run-time.

A Web server 420 sends the HTML code 422 to an optional XHTML normalizer 430, as described above. The normalizer 430 returns XHTML content 432.

The XHTML content 432 is sent to transcoders (or renderers) 440. The transcoder 440 transcodes the XHTML content 432 into the desired language, such as HDML 442, WML 444, cHTML, 446, HTML 448, or the like.

The software that accomplishes conversion of information from a first markup language into a second markup language can be programmed in C++. Alternatively, the software can be programmed in any other computer language that can transcode information from a first markup language into a second markup language. Additionally, the software can exist as a C++ ISAPI (“Internet Server API”) filter that runs on IIS (“MICROSOFT® Internet Information Server”) 4.0. Additionally, a MICROSOFT(®.NET C# class can be used to further enhance performance.

Additionally, an embodiment of the present invention may be implemented on a computer that can host IIS, for example, MICROSOFT WINDOWS NT® (Microsoft Corporation) 4.0 using IIS 4.0 or MICROSOFT WINDOWS 2000® using IIS 5.0 or higher, with MSXML (“MICROSOFT XML”) parser 3.0 July Beta or higher. Additionally, the present invention can be embodied in software using three files: echo.dll (the engine that performs device detection and markup conversion); conFIG. xml (the file that controls which Web applications can be used by the system and a variety of properties for each application); and browsercaps.xml (the file that controls mappings between device user agents and internal device classifications for renderers).

According to an embodiment of the present invention, the system that transcodes the information can also log errors for the user and/or the system with an error logging system. The error logging system keeps track of any problems/errors, in the form of an error log, that the system encounters while transcoding. Such errors include, for example, that a certain device could not be detected, that a markup language was identified for which a renderer did not exist, certain code could not be transcoded, or the like. The error log can be sent to the system operator, and the system operator can attempt to correct the error or pass on the error to the creator/developer of the system. Additionally, the error log may be stored in a file, or streamed to its desired recipient.

According to an embodiment of the present invention, the software that transcodes the information can be updated, in real-time or upon re-loading the software. The software can be updated with additional renderers that transcode different markup languages. These additional renderers can be added in real-time, such that the operator of the system would not have to shut down the software and re-load the software. In this embodiment, such additional renderers can be added in real-time because the renderers are not part of the software, but are a module that the software accesses when necessary. Thus, to add a new renderer, the operator of the system adds the renderer to the appropriate location on the system where renderers are located. When it is time for a renderer to be chosen by the software, the software considers the new renderer along with the other renderers already in the appropriate location.

The software that transcodes information can be housed on the Web server of the Web site being accessed. Thus, each Web site would have its own copy of the software. Alternatively, the software can be loaded on the computer (such as a mobile device) and thus the computer would transcode every Web page it receives.

According to another embodiment of the invention, automatic page division is used. Automatic page division is useful on large Web pages that contain a large amount of data such that the entire Web page would be difficult to view on a computer (such as a mobile device). Automatic page division works by dividing large Web pages into smaller, more manageable Web pages. The amount of code that a computer running a particular browser can accept (for example, 800 bytes at a time) is determined. The amount of code the computer can accept is determined by experimentation or by manufacturer specification. This amount of code that the computer can accept is integrated into the transcoders such that each transcoder is aware of how much data to send to its relevant destination device. While the Web page is transcoded, it is divided into pages that the computer can accept, such as 800 byte pages. When a user views one of the divided Web pages on his or her computer, he or she can click a “more” button (or something similar) to view the next divided Web page. Thus, the user can view the entire Web page on his or her computer. Automatic page division allows developers of Web pages to create Web pages as large as they desire while still allowing users with computers/browsers having limited capacities to view the entire Web page.

Additionally, according to an embodiment, special tags are used to identify the location a developer desires to have his or her Web page automatically page divided. Such tags indicate to the transcoding system that a page is to be divided at a certain location. Use of such tags prevents the Web page from being divided at an undesirable location.

According to another embodiment of the present invention, automatic object conversion can occur during transcoding. Automatic object conversion intelligently transcodes information embodied in an object that cannot (or is difficult) to display on some markup languages or devices into information embodied in an object that can be displayed by that markup language or device. For example, a check box with the title “Delete this message?” cannot be displayed on most mobile browsers. Using automatic object conversion, this message can be transcoded into a pick list with the choices “YES” and “NO” and the title “Delete this message?”, thus, allowing this message to be viewed on such mobile browsers. Similarly, other features in a first markup language that cannot be displayed using this language or the user's device can be intelligently transcoded such that these features are appropriately represented in the second markup language.

The methods and apparatus of the present invention, or certain aspects or portions thereof, may take the form of program code (e.g., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code that is transmitted over some transmission medium, such as over electrical wiring or cabling, through fiber optics, or via any other form of transmission (such as an electronic connection), wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

The steps depicted in flow charts and methods herein may be performed in a different order than as depicted and/or stated. The steps shown herein are merely exemplary of the order these steps may occur. The steps shown herein may occur in any order that is desired, such that the goals of the claimed invention are still achieved. Additionally, steps not desired to be used from the steps shown in the flow charts and methods may be eliminated, such that the goals of the claimed invention are still achieved.

All patents and publications described herein are hereby incorporated by reference to the same extent as if each individual patent or publication was specifically and individually indicated to be incorporated by reference.

One skilled in the art would readily appreciate that the present invention is well adapted to carry out the objects and obtain the ends and technical advantages mentioned, as well as those inherent therein. The specific systems and methods described herein as presently representative of preferred embodiments are exemplary and are not intended as limitations on the scope of the invention. Changes therein and other uses will occur to those skilled in the art which are encompassed within the spirit of the invention are defined by the scope of the claims.

It will be readily apparent to one skilled in the art that modifications may be made to the invention disclosed herein without departing from the scope and spirit of the invention. The invention illustratively described herein suitably may be practiced in the absence of any element or elements, limitation or limitations that is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group. For example, if there are alternatives A, B, and C, all of the following possibilities are included: A separately, B separately, C separately, A and B, A and C, B and C, and A and B and C.

Thus, additional embodiments are within the scope of the invention and within the following claims.

What is claimed is:

1. A method of transcoding information in a first markup language into a second markup language, the method comprising the steps of:
responding to a request to view a Web page by retrieving information from said Web page, wherein said information is in a first markup language;
normalizing said information;
determining a second markup language that can be used by a browser using device detection, wherein said browser is used by a computer that is to view said information; and
transcoding said information into said second markup language.

2. The method of claim 1, further comprising the step of sending said information in said second markup language to said computer.

3. The method of claim 2, wherein said computer is a wireless mobile device.

4. The method of claim 2, further comprising the step of streaming said information in said second language to said computer in real-time.

5. The method of claim 2 wherein the step of sending said information in said second markup language to said computer comprises sending said information to said computer using automatic page division.

6. The method of claim 1, wherein said step of transcoding comprises the steps of:
selecting a renderer that is associated with said second markup language from a plurality of renderers associated with markup languages;
sending said information through said renderer; and
transcoding said information into said second markup language using said renderer.

7. The method of claim 1, further comprising the step of adding in real-time an additional renderer that is associated with a markup language that is different from the markup languages associated with said plurality of renderers.

8. The method of claim 1, wherein said step of normalizing comprises the step of transcoding said information in said first markup language into an intermediate markup language.

9. The method of claim 8, wherein said intermediate markup language comprises the EXtensible HyperText Markup Language (“XHTML”).

10. The method of claim 1, wherein said second markup language comprises the EXtensible Markup Language (XML).

11. The method of claim 1, wherein said second markup language comprises the Wireless Markup Language (WML).

12. The method of claim 1, wherein said second markup language comprises the Compact HyperText Markup Language (cHTML).

13. The method of claim 1, wherein said second markup language comprises the Handheld Device Markup Language (HDML).

14. The method of claim 1, wherein said second markup language comprises the HyperText Markup Language (HTML).

15. The method of claim 1, wherein said steps of responding, normalizing, determining, and transcoding occur automatically.

16. The method of claim 1, wherein said first markup language comprises the HyperText Markup Language (HTML).

17. The method of claim 1, further comprising the step of sending said information in said second markup language to said computer over a system of networked computers.

18. The method of claim 1, wherein a first object embodies said information in said first markup language and said step of transcoding further comprises automatic object conversion of said first object to a second object embodying said information in said second markup language.

19. The method of claim 1, further comprising providing an error logging system.

20. The method of claim 1, wherein said second markup language is a markup language other than the HyperText Markup Language (HTML).

21. The method of claim 1, wherein said device detection comprises referring to an HTTP user agent header field.

22. The method of claim 1, wherein said device detection comprises detecting said browser and said computer using unique signature detection.

23. The method of claim 1, further comprising dividing said information in said second language into at least two pages using automatic page division.

24. A method of transcoding information in a first markup language into a second markup language, the method comprising the steps of:
responding to a request to view a Web page via a computer;
retrieving information from said Web page, wherein said information is in a first markup language;
normalizing said information; and
transcoding said information into a second markup language, wherein said computer is adapted for utilizing said second markup language.

25. The method of claim 24, wherein said step of normalizing comprises the step of transcoding said information in said first markup language into an intermediate markup language.

26. The method of claim 24, wherein said computer is a wireless mobile device.

27. The method of claim 24, further comprising the step of streaming said information in said second language to said computer in real-time.

28. The method of claim 24, further comprising dividing said information in said second language into pages using automatic page division.

29. The method of claim 24, wherein said step of transcoding comprises the steps of:
determining said second markup language, wherein said computer is adapted for utilizing said second markup language; selecting a renderer that is associated with said second markup language from a plurality of renderers associated with markup languages;
sending said information through said renderer; and
transcoding said information into said second markup language using said renderer.

30. The method of claim 29, further comprising the step of in real-time adding an additional renderer that is associated with a markup language that is different from the markup languages associated with said plurality of renderers.

31. The method of claim 24, wherein said steps of responding, retrieving, normalizing, and transcoding occur automatically.

32. The method of claim 24, wherein a first object embodies said information in said first markup language and said step of transcoding further comprises automatic object conversion of said first object to a second object embodying said information in said second markup language.

33. The method of claim 24, further comprising providing an error log that reports errors that occur during at least one of said steps of responding, retrieving, normalizing, and transcoding.

34. The method of claim 24, wherein said second markup language is a markup language other than the HyperText Markup Language (HTML).

35. The method of claim 24, further comprising the steps of:
detecting a browser of said computer; and
determining said second markup language that is used by said browser based on said step of detecting.

36. A method of transcoding information in a first markup language into a second markup language, the method comprising the steps of:
responding to a request to view a Web page;
retrieving information from said Web page, wherein said information is in a first markup language;
device detection to determine said second markup language that is used by said browser; and
transcoding said information into a second markup language, wherein said computer is adapted for utilizing said second markup language.

37. The method of claim 36, wherein said computer is a wireless mobile device.

38. The method of claim 36, further comprising the step of streaming said information in said second language to said computer in real-time.

39. The method of claim 36, wherein said step of transcoding comprises the steps of:
selecting a renderer that is associated with said second markup language from a plurality of renderers associated with markup languages;
sending said information through said renderer; and
transcoding said information into said second markup language using said renderer.

40. The method of claim 39, further comprising the step of adding in real-time an additional renderer.

41. The method of claim 36, wherein said steps of responding, retrieving, device detection and transcoding occur automatically.

42. The method of claim 36, further comprising dividing said information in said second language into pages using automatic page division.

43. The method of claim 36, wherein a first object embodies said information in said first markup language and said step of transcoding further comprises automatic object conversion of said first object to a second object embodying said information in said second markup language.

44. The method of claim 36, further comprising transcoding said information in said first markup language into an intermediate markup language prior to transcoding said information into second markup language.

45. A system for viewing a Web page by a computer that utilizes a markup language, the system comprising:
a computer, wherein said computer requests to view a Web page;
information from said Web page, wherein said information is in a first markup language;
a device detector, wherein said device detector determines a second markup language that said computer utilizes; and
a renderer, wherein said renderer transcodes said information into said second markup language, wherein said information is sent to said computer.

46. The system of claim 45, further comprising:
a normalizer, wherein said normalizer transcodes said information in said first markup language into an intermediate markup language.

47. The system of claim 45, further comprising a plurality of renderers and each of said plurality of renderers transcodes said information into a different markup language, wherein said renderer is selected from said plurality of renderers in real-time.

48. The system of claim 47, further comprising an additional renderer that is added in real-time.

49. The system of claim 45, wherein said computer utilizes a markup language other than the HyperText Markup Language (HTML).

50. The system of claim 45, wherein said computer is a wireless mobile device.

51. The system of claim 50, further comprising the step of streaming said information in said second language to said wireless mobile device in real-time.

52. The system of claim 45, wherein said renderer transcodes said information into said second markup language in real-time.

53. The system of claim 45, wherein said information in said second markup language is sent to said computer over a system of networked computers.

54. The system of claim 45, wherein a first object embodies said information in said first markup language and said renderer uses automatic object conversion to convert said first object to a second object embodying said information in said second markup language.

55. The system of claim 45, further comprising an error logging system.

56. The system of claim 45, wherein said second markup language is a markup language other than the HyperText Markup Language (HTML).

57. The system of claim 45, wherein said device detector uses unique signature detection.

58. A system for viewing a Web page by a computer that utilizes a markup language other than the HyperText Markup Language (HTML), the system comprising:
a computer, wherein said computer requests to view a Web page;
information from said Web page, wherein said information is in a first markup language;
a normalizer, wherein said normalizer normalizes said information in said first markup language into an intermediate markup language; and
a renderer, wherein said renderer transcodes said information in said intermediate markup language into a second markup language, wherein said second markup language is a markup language that said computer utilizes and said second markup language is a markup language other than HTML.

59. The system of claim 58, further comprising:
a device detector, wherein said device detector determines said second markup language based on a browser of said computer.

60. The system of claim 58, wherein said computer is a wireless mobile device.

61. The system of claim 58, wherein a first object embodies said information in said first markup language and said renderer uses automatic object conversion to convert said first object to a second object embodying said information in said second markup language.

62. Computer executable process steps operative to control a computer, stored on a computer readable medium, comprising:
a plurality of steps to receive data required for subsequent calculations; and
a plurality of steps to automatically transcode information in a first markup language into a second markup language, wherein said second markup language is automatically determined.

63. The steps of claim 62, further comprising a step to automatically normalize said information in said first markup language prior to transcoding said information into said second markup language.

64. A method of transcoding information in a first markup language into a second markup language, the method comprising the steps of:
(a) responding to a request to view a Web page;
(b) automatically retrieving information from said Web page, wherein said information is in a first markup language;
(c) automatically transcoding said information in said first markup language into an intermediate markup language;
(d) automatically detecting a browser used by a wireless mobile device that is to view said information;
(e) automatically determining a second markup language, wherein said second markup language is a markup language different from the first markup language and wherein said browser of said wireless mobile device is adapted for utilizing said second markup language;
(f) automatically selecting a renderer that is associated with said second markup language from a plurality of renderers;
(g) automatically sending said information in said intermediate language through said renderer, wherein said renderer coverts said information into said second markup language using smart automatic object conversion; and
(h) automatically streaming said information in said second markup language to said wireless mobile device in real-time over a system of networked computers.

65. The method of claim 64, further comprising adding in real-time an additional renderer.

66. The method of claim 64, further comprising dividing said information in said second language into pages using automatic page division.
